(19) United States
(12) Patent Application Publication
(10) Pub. No.: US 2005/0243108 A1
(43) Pub. Date: Nov. 3, 2005

(54) Display apparatus

(75) Inventor: Jin-bok Kim, Hwasung-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/118,449

(22) Filed: May 2, 2005

(30) Foreign Application Priority Data
May 1, 2004 (KR) 2004-0030829

(51) Int. Cl. G09G 5/00

(52) U.S. Cl. 345/690

(57) ABSTRACT

A display apparatus displaying a picture based on a video signal, including a color temperature transformer detecting a transform objective pixel distributed within a transform objective space defined by an achromatic color and a set of colors adjacent to the achromatic color in a color coordinates system among pixels of the video signal and transforming the color temperature of the transform objective pixel; and a controller controlling the color temperature transformer to transform the color temperature of the transform objective pixel on the basis of a preset color temperature.

### CROSS-REFERENCE TO RELATED APPLICATIONS

This application claims the benefit of Korean Patent Application No. 2004-0030829, filed May 1, 2004, in the Korean Intellectual Property Office, the disclosure of which is incorporated herein by reference.

### BACKGROUND OF THE INVENTION

1. Field of the Invention

The present invention relates to a display apparatus and, more particularly, to a display apparatus that can transform a color temperature of a pixel distributed within a transform objective space defined by an achromatic color and a set of colors adjacent to the achromatic color in a color coordinates system.

2. Description of the Related Art

Generally, a display apparatus, particularly a color display apparatus, has been widely used in devices such as a television (TV), a digital TV (DTV), a thin film transistor (TFT) monitor or TV, a color printer, a digital camera, a projector, a mobile phone, etc., which transmit visible information to a user.

In the conventional display apparatus displaying a picture, a video signal inputted thereto is variously processed with regard to hue, lightness, saturation, color temperature, etc. in order to adjust a display state of the picture.

However, in the conventional display apparatus, when the color temperature is transformed by a user, the transformed color temperature has an effect on the whole picture. Therefore, in the case where the transformed color temperature is substantially different from a default color temperature, a predetermined color such as a face color, a sky color, etc. is deteriorated, so that a picture is displayed with unnatural colors. For this reason, a manufacturer limits a user transformable range of the color temperature to a predetermined range even if the user wants a larger transformable range.

### SUMMARY OF THE INVENTION

Accordingly, it is an aspect of the present invention to provide a display apparatus, which can transform a color temperature of a pixel distributed within a transform objective space defined by an achromatic color and a set of colors adjacent to the achromatic color in a color coordinate system.

The foregoing and/or other aspects of the present invention are also achieved by providing a display apparatus displaying a picture based on a video signal, comprising a color temperature transformer detecting a transform objective pixel distributed within a transform objective space defined by an achromatic color and a set of colors adjacent to the achromatic color in a color coordinate system among pixels of the video signal, and transforming the color temperature of the transform objective pixel; and a controller controlling the color temperature transformer to transform the color temperature of the transform objective pixel on the basis of a preset color temperature.

According to an embodiment of the present invention, the color coordinate system comprises a YCbCr color coordinate system.

According to an embodiment of the present invention, the transform objective space has a pyramid shape with respect to a Y-axis of the YCbCr color coordinate system.

According to an embodiment of the present invention, the transform objective space has an elliptical section in parallel with a Cb-Cr plane of the YCbCr color coordinates system.

According to an embodiment of the present invention, the color temperature transformer varies a transformation rate for the preset color temperature in correspondence to brightness levels of the transform objective pixel.

According to an embodiment of the present invention, the color temperature transformer divides the transform objective space into a plurality of brightness sections according to the brightness levels and weights each brightness section with regard to the color temperature transformation corresponding to the preset color temperature.

According to an embodiment of the present invention, the display apparatus further comprises a UI generator to provide a user interface allowing a user to input the preset color temperature.

According to an embodiment of the present invention, the user interface comprises a reference screen with an invariable picture based on color temperatures that are different from each other, an adjusting screen to adjust the display state of a picture depending on the preset color temperature, and a color temperature input unit allowing a user to input the preset color temperature.

According to an embodiment of the present invention, the display apparatus further comprises a UI data storage to store data for displaying the user interface having the picture displayed on the reference screen and the adjusting screen.

According to an embodiment of the present invention, the controller controls the color temperature transformer to set the whole color space in the color coordinate system as the transform objective space.

### BRIEF DESCRIPTION OF THE DRAWINGS

The above and/or other aspects and advantages of the present invention will be readily apparent and appreciated from the following description of the exemplary embodiments taken in conjunction with the accompany drawings, of which:

FIG. 1 is a control block diagram of a display apparatus according to an embodiment of the present invention;

FIG. 2 is a control block diagram of a display apparatus with a signal processor according to an embodiment of the present invention;

FIG. 3 is a view illustrating a color space and a transform objective space in a YCbCr coordinate system;

FIG. 4 is a control flowchart of a display apparatus according to an embodiment of the present invention;

FIG. 5 is a view illustrating interpolation of color coordinate depending on a color temperature according to an embodiment of the present invention;

FIG. 6 is a view illustrating interpolation of color coordinates depending on brightness of a transform objective pixel according to an embodiment of the present invention;

FIGS. 7 and 8 are views of illustrating a color temperature transform according to an embodiment of the present invention; and

FIG. 9 is a view illustrating a user interface according to an embodiment of the present invention.

### DETAILED DESCRIPTION OF ILLUSTRATIVE, NON-LIMITING EMBODIMENTS OF THE INVENTION

Reference will now be made in detail to illustrative, non-limiting embodiments of the present invention, examples of which are illustrated in the accompanying drawings, wherein like reference numerals refer to like elements throughout. The embodiments are described below in order to explain the present invention by referring to the figures.

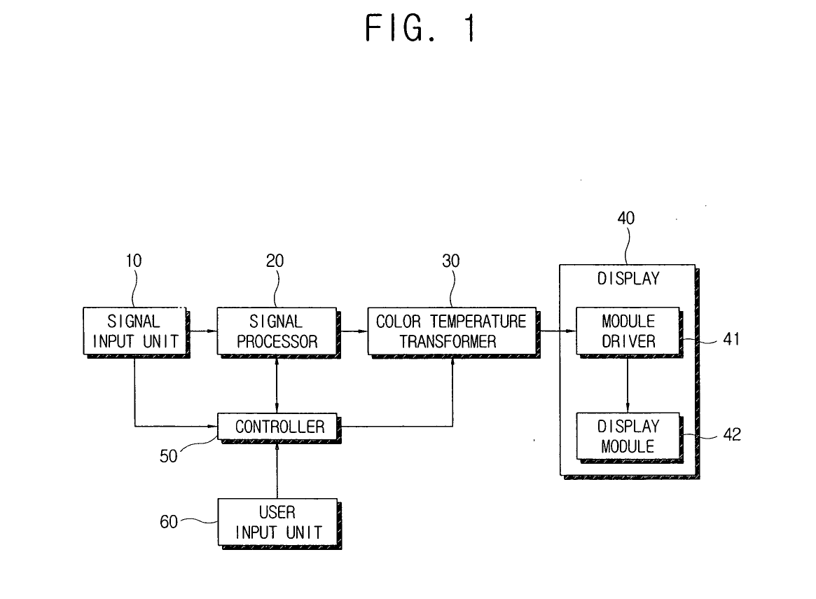

As shown in FIG. 1, a display apparatus according to an embodiment of the present invention comprises a display 40 displaying a picture thereon; a signal processor 20; a signal input unit 10; a color temperature transformer 30; and a controller 50 controlling the display 40, the signal processor 20, the signal input unit 10, and the color temperature transformer 30.

The display 40 receives a video signal from the color temperature transformer 30 and displays a picture thereon. The display 40 comprises a display module 42 displaying a picture thereon and a module driver 41 processing the video signal received from the color temperature transformer 30 and driving the display module 42 to display a picture thereon. According to an embodiment of the present invention, the display module 42 includes various modules such as a digital light processing (DLP) device, a liquid crystal display (LCD), a plasma display panel (PDP), etc. In the case of the DLP device, the module driver 41 comprises an optical engine. In the case of the LCD, the module driver 41 comprises a printed circuit board (PCB) to convert the video signal received from the color temperature transformer 30 into a data signal and a gate signal. Likewise, in the display 40, the module driver 41 has a configuration corresponding to the display module 42.

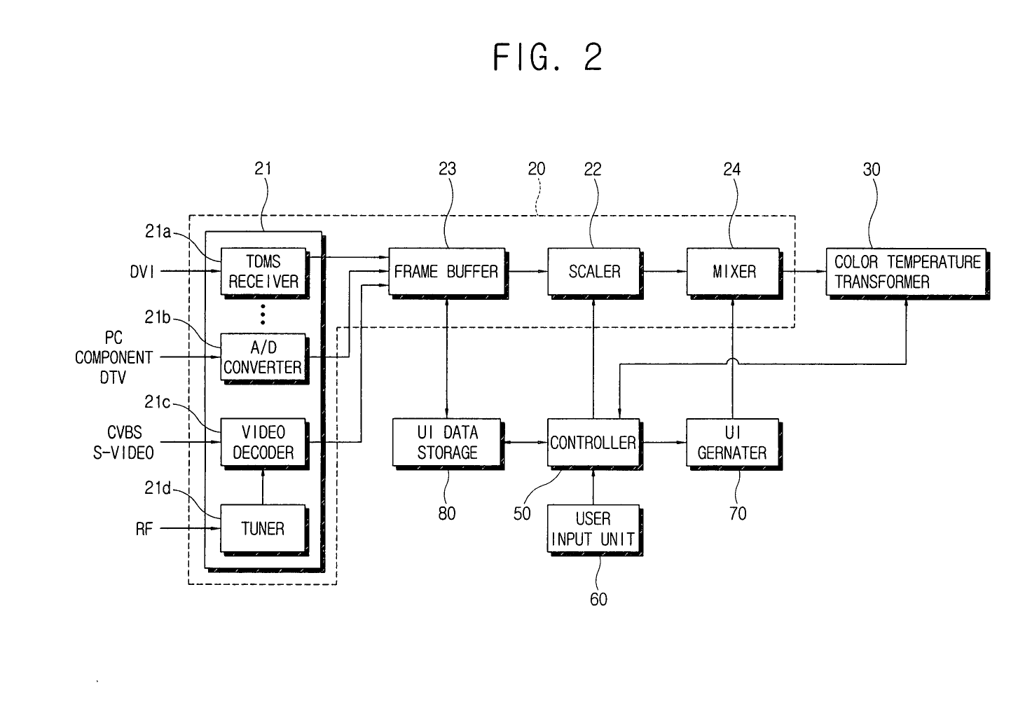

The signal processor 20 processes the video signal inputted through the signal input unit 10 to have a format suitable to the display 40. As shown in FIG. 2, the signal processor 20 according to an embodiment of the present invention comprises a scaler 22 and a signal converter 21 converting the video signal to have a format suitable to the scaler 22. Further, the signal converter 21 may comprise a transition minimized differential signaling (TMDS) receiver 21a, an A/D converter 21b, a video decoder 21c, a tuner 21d, etc. in correspondence to the format of the video signal.

The TMDS receiver 21 a receives a digital video signal such as a DVI signal from the outside through a digital connection terminal (not shown) of the signal input unit 10 and divides the digital video signal into an RGB digital signal and an H/V synchronous signal, thereby outputting the RGB digital signal and the H/V synchronous signal to the scaler 22. The A/D converter 21b converts an analog video signal such as a component signal, a personal computer signal, etc. received through the signal input unit 10 into a digital video signal, thereby outputting the digital video signal to the scaler 22. The video decoder 21c decodes an analog video signal such as a composite video broadcast signal (CVBS) signal, an S-video signal, etc. inputted through an analog connection terminal (not shown) and outputs the decoded video signal to the scaler 22. The tuner 21d receives a radio frequency (RF) broadcast signal through an antenna (not shown) and outputs the broadcast signal to the video decoder 21c.

The scaler 22 converts the video signal outputted from the signal converter 21 to have a vertical frequency, resolution, an aspect ration, etc. suitable for an output regulation of the display 40.

Further, the signal processor 20 may comprise a frame buffer 23 temporarily storing the video signal outputted from the signal converter 21 by a frame and outputting the video signal to the scaler 22.

The signal input unit 10 receives the video signal and outputs the received video signal to the signal processor 20. Here, the signal input unit 10 may have various configurations in correspondence to the signal converter 21 of the signal processor 20. For example, the signal input unit 10 may comprise an analog input terminal to receive the analog video signal and output it to the A/D converter 21b and a digital input terminal to support a low voltage differential signaling (LVDS) interface or a TMDS interface for the digital video signal.

The controller 50 controls the signal processor 20, the color temperature transformer 30, and a signal input unit 10. According to an embodiment of the present invention, the controller 50 controls the signal processor 20 and the color temperature transformer 30 on the basis of a control signal inputted through a user input unit 60 (to be described later), thereby adjusting a display state of the picture displayed on the display 40.

The color temperature transformer 30 detects a pixel (hereinafter, referred to as “transform objective pixel”) distributed within a transform objective space “TS” defined by a color coordinate system among pixels based on the input video signal, and transforms the color temperature of the detected transform objective pixel into a preset color temperature. Here, the transform objective space “TS” is defined by an achromatic color and a set of colors adjacent to the achromatic color in the color coordinate system.

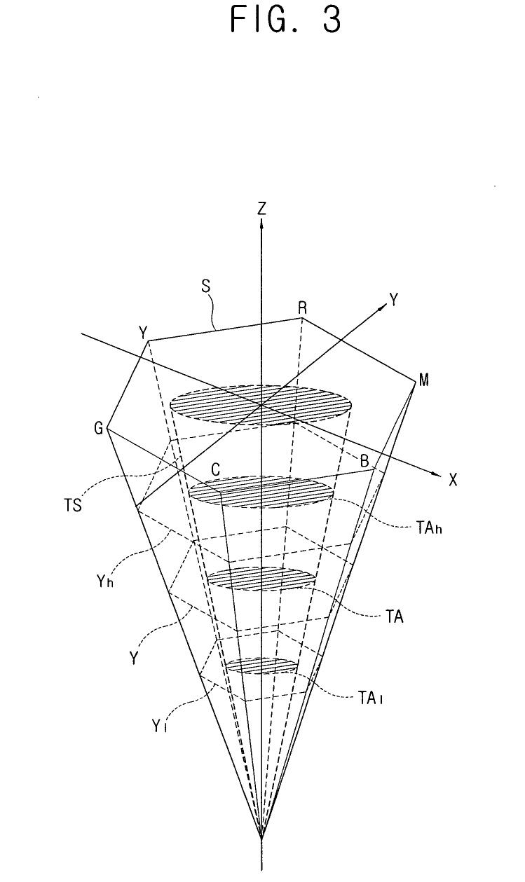

The video signal inputted to the color temperature transformer 30 includes a brightness signal determining the brightness of a pixel and a color difference signal. Here, as shown in FIG. 3, the color coordinates according to an embodiment of the present invention comprises a YCbCr color coordinate system defined by the brightness signal and the color difference signal, by way of example. Therefore, the transform objective space “TS” defined by the achromatic color and the set of colors adjacent to the achromatic color in the color coordinate system is shaped like a pyramid. Further, the color coordinate system comprises a CIELAB (L*a*b*) color coordinate system, a CIELCH (L*C*h*) color coordinate system, etc., which are proposed by the commission international de eclairage (CIE). Besides the above coordinate systems, the color coordinate system can comprise other coordinate systems as long as it does not depart from the principles and spirit of the invention. Because the mapping method for coordinates between the color coordinate systems is well known, descriptions thereof will be omitted. Thus, the color temperature transforming method according to the present invention using the YCbCr color coordinate system can be also applied to other coordinate systems by using the well-known mapping method for coordinates between the color coordinate systems.

In the YCbCr color coordinate system shown in FIG. 3, the color distributed on a brightness axis (Y) corresponds to the achromatic color, so that a coordinate transformation on a Cb-Cr plane means a color temperature transformation of the same brightness. By way of example, the YCbCr color coordinates according to an embodiment of the present invention comprise a color space shaped like a hexagonal pyramid formed by six axes corresponding to six basic colors such as red (R), yellow (Y), green (G), cyan (C), blue (B), and magenta (M).

Meanwhile, a section of the transform objective space “TS” cut by the Cb-Cr plane is geometrically defined as a transform objective area. For example, in the case where the transform objective areas “TAh”, “TA” and “TAl” have an elliptical shape as shown in FIG. 3, the transform objective areas “TAh”, “TA” and “TAl” can be represented by an elliptical equation in the color coordinate system.

Here, the color temperature transformer 30 detects whether each of the pixels based on the input video signal is the transform objective pixel distributed within the transform objective space “TS”, and transforms the color temperature of corresponding pixel into the preset color temperature when the pixel of the video signal is determined as the transform objective pixel. At this time, the controller 50 controls the color temperature transformer 30 to transform the color temperature of the transform objective pixel on the basis of the preset color temperature inputted or previously set by a user.

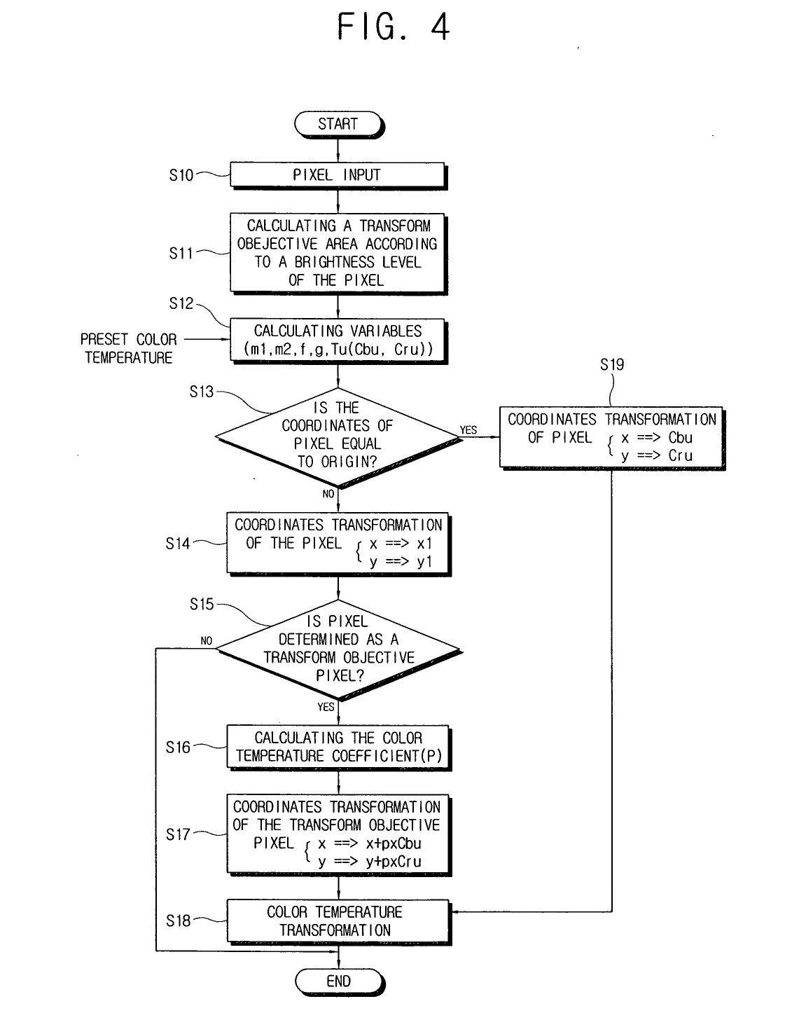

Hereinbelow, the color temperature transform method by the color temperature transformer 30 and the controller 50 will be described with reference to FIG. 4. Here, the transform objective areas “TAh”, “TA” and “TAl” have an elliptical shape by way of example.

When the video signal for the respective pixels is inputted at operation SI 0, the transform objective areas “TAh”, “TA” and “TAl” in the transform objective space “TS” are calculated at operation S11, as follows. Here, variables to determine the transform objective areas “TAh”, “TA” and “TAl” in the transform objective space “TS” corresponding to the input pixels includes an elliptical major axis variable “α”, an elliptical minor axis variable “β”, a rotational angle “θ” with respect to X-axis of a major axis, and a bright scaling factor “k”.

First, a base distance “Base_Dist” of the elliptical major axis to determine the transform objective areas “TAh”, “TA” and “TAl” is defined by the following equation 1.
Base_{—}Dist=k×Y [Equation 1]

Where, Y is a brightness level of the pixel.

A major axis distance “a” is calculated by the following equation 2, using the variable “α”.
a=α×Base_{—}Dist[Equation 2]

A minor axis distance “b” is calculated by the following equation 3, using the variable “β”.
b=β×a [Equation 3]

Thus, the transform objective areas “TAh”, “TA” and “TAl” in the transform objective space “TS” are defined according to the brightness levels as the elliptical shapes having the different major and minor axis distances, respectively. Further, variables “m1”, “m2”, “f”, “g”, “Tu(Cbu, Cbr)” for the color temperature transformation at operation S12 are calculated as follows.

First, coefficients of a rotation matrix at the rotational angle “0” are calculated by the following Equations 4 and 5.
m1=cos(−θ) [Equation 4]
m2=sin(−θ) [Equation 5]

The variables “f” and “g” of the elliptical equation are calculated by the following equations 6 and 7, using the squared major axis distance “a” and the squared minor axis distance “b”.
f=1/a² [Equation 6]
g=1/b² [Equation 7]

When coordinates of the input pixel is P(x,y), the rotated coordinate of P1(x1,Y1) is calculated by the following equations 8 and 9.
x1=(m1×x)−(m2×y) [Equation 8]
y1=(m2×x)−(m1×y) [Equation 9]

Then, whether the input pixel P(x,y) is the transform objective pixel is determined by the following equation 10.
(f×x1)+(g×y1)≦1 [Equation 10]

Here, if the input pixel satisfies equation 10, the input pixel is determined to be the transform objective pixel. Conversely, if the input pixel does not satisfy the equation 10, the input pixel is not determined to be the transform objective pixel.

Further, the color temperature transformer 30 calculates target color coordinates “Tu(Cbu,Cru)” in correspondence to the brightness signal and the color difference signal of the transform objective pixel as follows. In this case, the color temperature transformer 30 includes a lookup table storing coordinates with respect to the color temperatures and the brightness levels (refer to the following table 1).

TABLE 1

| Index | brightness | T1 | T2 | . . . | TM−1 | TM |
|---|---|---|---|---|---|---|
| 1 | Y1 | Cb1_T1, | Cb1_T2, | . . . | Cb1_TM−1, | Cb1_TM, |
| | | Cr1_T1 | Cr1_T2 | | Cr1_TM−1 | Cr1_TM |
| 2 | Y | Cb2_T1, | Cb2_T2, | . . . | Cb2_TM−1, | Cb2_TM, |
| | | Cr2_T1 | Cr2_T2 | | Cr2_TM−1 | Cr2_TM |
| 3 | Y | Cb3_T1, | Cb3_T2, | . . . | Cb3_TM−1, | Cb3_TM, |
| | | Cr3_T1 | Cr3_T2 | | Cr3_TM−1 | Cr3_TM |
| 4 | Y | Cb4_T1, | Cb4_T2, | . . . | Cb4_TM−1, | Cb4_TM, |
| | | Cr4_T1 | Cr4_T2 | | Cr4_TM−1 | Cr4_TM |
| . | . | . | . | . | . | . |
| . | . | . | . | . | . | . |
| . | . | . | . | . | . | . |
| N−1 | Yn−1 | CbN−1_T1, | CbN−1_T2, | . . . | CbN−1_TM−1, | CbN−1_TM, |
| | | CrN−1_T1 | CrN−1_T2 | | CrN−1_TM−1 | CrN−1_TM |
| N | YN | CbN_T1, | CbN_T2, | . . . | CbN_TM−1, | CbN_TM, |
| | | CrN_T1 | CrN_T2 | | CrN_TM−1 | CrN_TM |

First, the color temperature transformer 30 detects two sample brightness level (Yl,Yh) from the lookup table, wherein (Yl,Yh) should satisfy the following equation 11.
Yl<Y<Yh[equation 11]

Here, the sample brightness levels (Yl,Yh) are previously set. In the case of 8-bit he sample brightness level ranges from 0 to 255. If there are sixteen sample ness levels (N=16) at regular intervals, the difference between the sample brightness can be 16. That is, the sample brightness levels are 0, 16, 32, 48, and so on. For e, if “Y” is 37, “Yl” and “Yh” are 32 and 48, respectively.

Then, the color temperature transformer 30 detects sample color temperatures (Tl,Th) from the lookup table, wherein (Tl,Th) should satisfy the following equation 12.
Tl<Tu≦Th [equation 12]

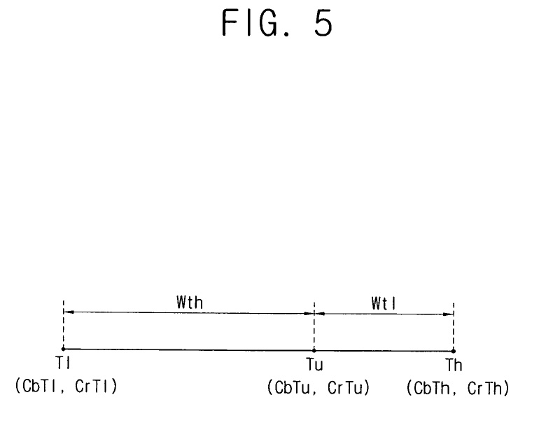

Further, coordinates corresponding to the preset color temperature “Tu” with respect to two sample brightness level (Yl,Yh) are calculated by the following equations 13 and 14 using interpolation. For example, let the coordinates corresponding to the color temperatures “Tl” and “Th” with respect to one sample brightness level be (CbTl, CrTl) and (CbTh, CrTh), respectively. Then, the color coordinates (CbTu, CrTu) corresponding to the color temperature “Tu” are calculated by a weighted interpolation of the difference between the preset color temperature and two sample color temperatures in the color coordinates (refer to the following equations 15 and 16). To help understanding, FIG. 5 illustrates such interpolation of the color coordinates depending on the color temperatures, by way of example.
Wtl=(Th−Tu)/(Th−Tl) [Equation 13]
Wth=(Tu−Tl)/(Th−Tl) [Equation 15]
CbTu=(Wtl×CbTl)+(Wth×CbTh) [Equation 14]
CrTu=(Wtl×CrTl)+(Wth×CrTh) [Equation 16]

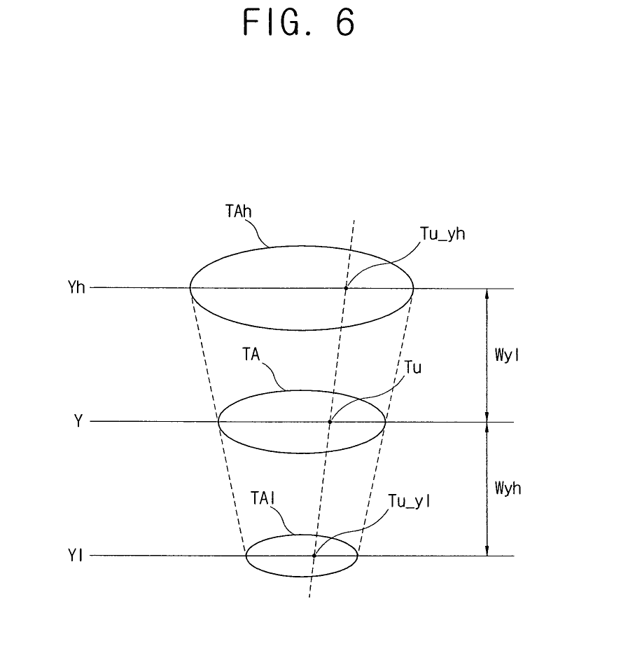

Meanwhile, in the case where the coordinates corresponding to the preset color temperatures “Tu” respectively calculated with respect to two sample brightness levels “(Yl,Yh)” are “Tu_yl(CbTu_l,CrTu_l)” and Tu_yh(CbTu_h,CrTu_h), the coordinates corresponding to the preset color temperature “Tu(Cbu,Cru)” with regard to the brightness signal “Y” of the transform objective pixel are calculated by a weighted interpolation of the difference between the brightness level “Y” and two sample brightness levels in the color coordinates (refer to the following equations 17, 18, 19 and 20). At this time, the calculated color coordinates are the target color coordinates “Tu(Cbu,Cru)”. FIG. 6 illustrates such interpolation of the color coordinates depending on the brightness level.
Wyl=(Yh−Y)/(Yh−Yl) [Equation 17]
Wyh=(Y−Yl)/(Yh−Yl) [Equation 18]
Cbu=(Wyl×CbTu₁₃ l)+(Wyh×CbTu_{—}h) [Equation 19]
Cru=(Wyl×CrTu_{—}l)+(Wyh×CrTu_{—}h) [Equation 20]

As described above, when the target color coordinates “Tu(Cbu,Cru)” are determined corresponding to the brightness signal and the color difference signal of the transform objective pixel, the color temperature transformer 30 performs a transformation to move the coordinates of the input pixel to the target color coordinates “Tu(Cbu,Cru)” in proportion to the movement of the reference coordinates disposed within the transform objective area “TA”, for example, in proportion to the movement of the origin of the ellipse.

First, let the coordinates of the transform objective pixel be P(x,y). Then, at operation S13, the color temperature transformer 30 determines whether the coordinates P(x,y) of the transform objective pixel are equal to the reference coordinates, e.g., the origin of the ellipse. When P(x,y) is equal to the coordinates of the ellipse, at operation S19, the coordinates P(x,y) of the input pixel is transformed into the target color coordinates “Tu(Cbu,Cru)” by the color temperature transformer 30.

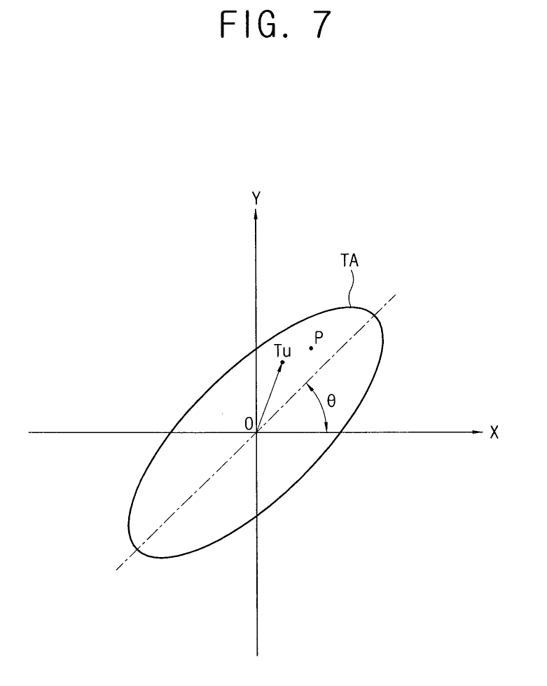

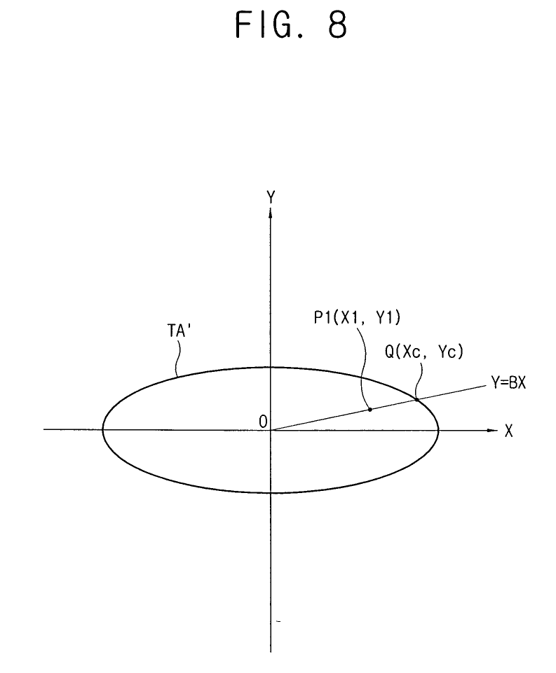

Contrarily, when the coordinates P(x,y) of the transform objective pixel is not equal to the origin of the ellipse, at operation S14, the coordinates P(x,y) of the transform objective pixel is transformed into the coordinates P(x1,y1) of a coordinate system formed with respect to the major and minor axes of the ellipse to define the transform objective space “TS”. At this time, the coordinates P(x,y) of the transform objective pixel is transformed by the following equation 21. FIG. 7 illustrates the coordinates system before the transform objective area “TA” is transformed by the equation 21, and FIG. 8 illustrates the coordinates system after the transform objective area “TA” is transformed by the equation 21.

$$( \begin{matrix}x 1 \\ y 1\end{matrix} ) = ( \begin{matrix}m 1 & - m 2 \\ m 2 & m 1 \end{matrix} ) ( \begin{matrix}x \\ y\end{matrix} ) \qquad [ Equation 21 ]$$

Then, it is determined whether or not the coordinates transformed by the equation 21 is distributed within the transform objective space “TS”. When the coordinates of the input pixel is distributed within the transform objective space “TS”, at operation S15, whether the input pixel is the transform objective pixel or not is determined by the foregoing equation 10.

Here, when the input pixel is not the transform objective pixel, the color temperature transformer 30 transmits the input pixel to the display 40 without the color transformation. Conversely, when the input pixel is the transform objective pixel, the color temperature transformer 30 calculates a color temperature transformation coefficient “p” to transform the color temperature of the input pixel. Here, at operation S16, the color temperature transformation coefficient “p” is calculated by the following equations 22 and 23.

$$r = \sqrt{x {c}^{2} + y {c}^{2}} = \sqrt{\frac{1 + {B}^{2}}{f + g \times {B}^{2}}} \qquad [ Equation 22 ]$$

Where, B=y1/x1; r=1/g at x1=0; r=1/f at y1=0; and (xc,yc) means the coordinates of a point “Q”.

$$p = \frac{r - \sqrt{{x}^{2} + {y}^{2}}}{r} \qquad [ Equation 23 ]$$

Then, at operation S17, the color coordinates of the transform objective pixel is transformed by the following equation 24.

$${P}^{′} = ( \begin{matrix}x \\ y\end{matrix} ) + p ( \begin{matrix}Cbu \\ Cru\end{matrix} ) \qquad [ Equation 24 ]$$

Then, at operation S 18, the input pixel is changed in the color temperature of corresponding to the transformed coordinates P′(x′,y′) and then transmitted to the display 40.

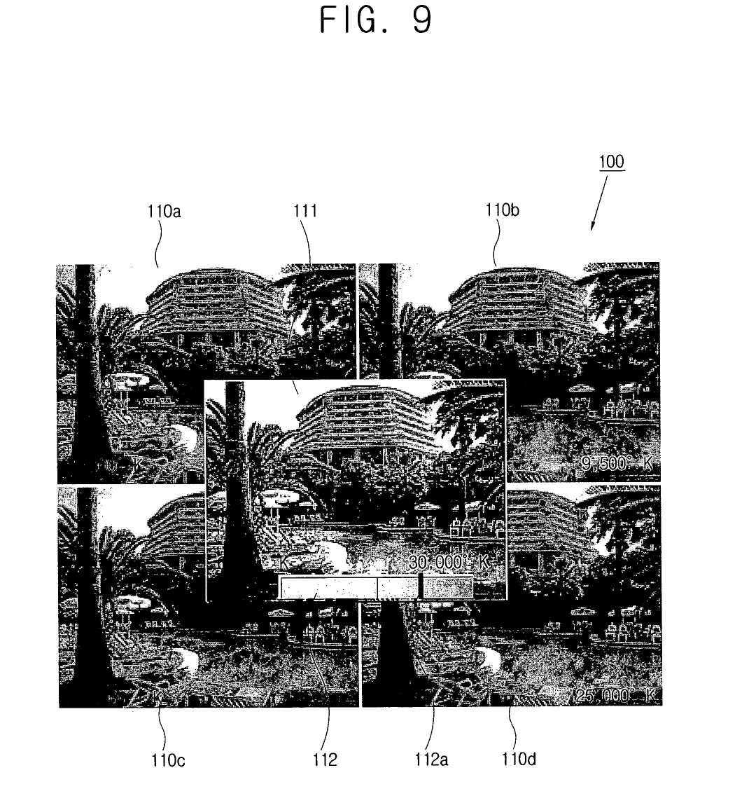

Meanwhile, referring to FIGS. 2 and 9, the display apparatus according to an embodiment of the present invention further comprises a user interface (UI) generator 70 which provides a user interface 100 allowing a user to transform the color temperature of the pixel distributed within the transform objective space “TS”. Here, the video signal for the user interface 100 outputted from the UI generator 70 is inputted to a mixer 24 of the signal processor 20, and the mixer 24 mixes the video signal from the signal input unit 10 with the video signal from the UI generator 70 and outputs the mixed video signal to the color temperature transformer 30.

Further, the display apparatus according to an embodiment of the present invention comprises a user input unit 60 transmitting a control signal to the controller 50 when a user changes the color temperature through a color adjusting portion 112 of the user interface 100 shown in FIG. 9. Here, the user input unit 60 comprises an on screen display (OSD) button provided in the front of the display apparatus, an input unit of a computer such as a keyboard, a mouse, etc. connected to the display apparatus, and a remote controller.

FIG. 9 illustrates the user interface 100 according to an embodiment of the present invention. As shown therein, the user interface 100 according to an embodiment of the present invention comprises an adjusting screen 111, and reference screens 110a, 110b, 110c and 110d.

The reference screens 110a, 110b, 110c and 110d comprises a plurality of invariable pictures according to predetermined color temperatures, and the adjusting screen 111 comprises a variable picture depending on the color temperature selected by a user.

Here, it is preferable that the picture for the reference screens 110a, 110b, 110c and 110d and the adjusting screen 111 contains an image allowing a user to easily recognize difference according to the color temperatures. For example, a landscape, a portrait, a building, light and shade are selected according to the color temperatures. In FIG. 9, four invariable pictures each having the color temperatures of 6,500K, 9,500K, 1,300K and 25,000K are illustrated as the reference screens 110a, 110b, 110c and 110d by way of example, but the present invention is not limited to these examples. Alternatively, the reference screens may comprise less than four or more than four reference screens as deemed necessary.

Here, data about the picture or the like to be displayed on the reference screens 110a, 110b, 110c and 110d and the adjusting screen 111 for the user interface 110 is stored in a UI data storage 80. According to an embodiment of the present invention, the UI data storage 80 comprises a flash memory. The UI data storage 80 outputs the data to the frame buffer 23 of the signal processor 20 according to a control of the controller 50.

The controller 50 controls the color temperature transformer 30 on the basis of the color temperature set through the adjusting screen 111. Preferably, but not necessarily, the adjusting screen 111 comprises the color adjusting portion 112 provided with a drag bar 1112a. Thus, the controller 50 recognizes the adjustment of the drag bar 112a by a user and transmits information about the color temperature set by a user to the color temperature transformer 30.

In the foregoing embodiment, the target color coordinates are calculated according to the brightness levels of the transform objective pixel, thereby transforming the color temperature. However, the transform objective space may be divided according to the brightness levels at regular intervals, and the target color coordinates, with respect to the brightness level, may be previously stored in the lookup table so that the color temperature is transformed by reading the target color coordinates corresponding to the brightness level of the transform objective pixel from the lookup table.

Thus, the color temperature transformer 30 detects the transform objective pixel distributed within the transform objective space “TS” defined by the achromatic color and the set of colors adjacent to the achromatic color in the color coordinate system among the pixels of a video signal so as to transform the color temperature of the transform objective pixel, and the controller 50 controls the color temperature transformer 30 to transform the color temperature of the transform objective pixel on the basis of the preset color temperature so that only the pixel distributed in the transform objective space “TS” is transformed in the color temperature, thereby preventing a predetermined color such as a face color, a sky color, etc. from being deteriorated according to the color temperature transformation and allowing the transformable range of the color temperature to be widened.

As described above, the present invention provides a display apparatus, which can transform a color temperature of a pixel distributed within a transform objective space defined by an achromatic color and a set of colors adjacent to the achromatic color in a color coordinates system, thereby preventing a predetermined color such as a face color, a sky color, etc. from being deteriorated according to the color temperature transformation, and allowing the transformable range of the color temperature to be widened.

Further, the present invention provides a display apparatus, in which colors distributed within a transform objective area are transformed in a weighted proportion to a pixel and a color difference, thereby displaying the colors without interruption due to the color temperature transformation, in other words, minimizing unavailable colors.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

1. A display apparatus displaying a picture based on a video signal, comprising:
a color temperature transformer detecting a transform objective pixel distributed within a transform objective space defined by an achromatic color and a set of colors adjacent to the achromatic color in a color coordinate system among pixels of the video signal and transforming the color temperature of the transform objective pixel; and
a controller controlling the color temperature transformer to transform the color temperature of the transform objective pixel on the basis of a preset color temperature.

2. The display apparatus according to claim 1, wherein the color coordinate system comprises a YCbCr color coordinate system.

3. The display apparatus according to claim 2, wherein the transform objective space has substantially a pyramid shape with respect to a Y-axis of the YCbCr color coordinate system.

4. The display apparatus according to claim 3, wherein the transform objective space has an elliptical section in parallel with a Cb-Cr plane of the YCbCr color coordinate system.

5. The display apparatus according to claim 1, wherein the color temperature transformer varies a transformation rate for the preset color temperature in correspondence to brightness levels of the transform objective pixel.

6. The display apparatus according to claim 1, wherein the color temperature transformer divides the transform objective space into a plurality of brightness sections according to the brightness levels and weights each brightness section with regard to the color temperature transformation corresponding to the preset color temperature.

7. The display apparatus according to claim 1, further comprising a UI generator to provide a user interface allowing a user to input the preset color temperature.

8. The display apparatus according to claim 7, wherein the user interface comprises a reference screen with an invariable picture based on color temperatures that are different from each other, an adjusting screen to adjust a display state of a picture depending on the preset color temperature, and a color temperature input unit allowing a user to input the preset color temperature.

9. The display apparatus according to claim 8, further comprising a UI data storage to store data for displaying the user interface having the picture displayed on the reference screen and the adjusting screen.

10. The display apparatus according to claim 1, wherein the controller controls the color temperature transformer to set the whole color space in the color coordinate system as the transform objective space.
